(19) United States
(12) Patent Application Publication
(10) Pub. No.: US 2019/0264599 A1
(43) Pub. Date: Aug. 29, 2019

(54) VEHICLE FRONT STRUCTURE

(71) Applicant: TOYOTA JIDOSHA KABUSHIKI KAISHA, Toyota-shi (JP)

(72) Inventors: Hiroyuki BANDAI, Nagakute-shi (JP); Takeaki TOEDA, Toyota-shi (JP); Takashi URAHAMA, Ichinomiya-shi (JP)

(73) Assignee: TOYOTA JIDOSHA KABUSHIKI KAISHA, Toyota-shi (JP)

(21) Appl. No.: 16/239,378

(22) Filed: Jan. 3, 2019

(30) Foreign Application Priority Data
Feb. 28, 2018 (JP) 2018-034912

(51) Int. Cl. F01P 5/06; F01P 11/10; B60K 11/08

(52) U.S. Cl. CPC F01P 5/06; F01P 2050/22; B60K 11/08; F01P 11/10

(57) ABSTRACT

The vehicle front structure includes a radiator located in a vehicle front so that air passes through a vehicle rear, a radiator fan located in the vehicle rear of the radiator so as to generate an air flow flowing from the vehicle front to the radiator, an engine located in the vehicle rear of the radiator fan, and an engine soundproof cover having a front cover portion for covering a portion of a front surface of the engine, and guiding the air passing through the radiator fan to flow upward of the engine by using the front cover portion.

### CROSS-REFERENCE TO RELATED APPLICATION

This application is based on Japanese Patent Application No. 2018-034912 filed with Japan Patent Office on Feb. 28, 2018, the entire contents of which are hereby incorporated by reference.

### TECHNICAL FIELD

The present disclosure relates to a vehicle front structure.

### BACKGROUND

Germany Unexamined Patent Publication No. 10244800 discloses a vehicle front structure. The vehicle front structure has a soundproof cover of an engine. A first soundproof cover is located with a gap left from the engine between the engine and an engine hood (bonnet). A second soundproof cover is located with a gap left from an engine component at a position between the engine component and the engine hood where a high thermal load is applied upward and rearward of the engine. When a vehicle travels, some of air supplied to the engine compartment from a radiator grill passes through a first flow channel between the first soundproof cover and the engine hood. Thereafter, the air is supplied to a second flow channel between the second soundproof cover and the engine component. In this way, the vehicle front structure uses rain pressure so as to supply the air to an air flow channel formed inside the engine hood, and cools the engine component located behind the engine.

### SUMMARY

According to the vehicle front structure disclosed in Germany Unexamined Patent Publication No. 1024480, when the vehicle travels at low speed, external air is not sufficiently supplied to the engine compartment. Consequently, although a soundproof function can be fulfilled, a cooling function cannot be sufficiently fulfilled, thereby causing a possibility that the engine may be filled with heat. The present disclosure provides the vehicle front structure in which the soundproof function can be fulfilled and the cooling function can be fulfilled even while the vehicle travels at low speed.

According to an aspect of the present disclosure, there is provided a vehicle front structure including a radiator located in a vehicle front and configured to guide air to pass through a vehicle rear, a radiator fan located in the vehicle rear of the radiator and configured to generate an air flow flowing from the vehicle front to the radiator, an engine located in the vehicle rear of the radiator fan, and an engine soundproof cover having a front cover portion for covering a portion of a front surface of the engine, and configured to guide the air passing through the radiator fan so as to flow upward of the engine by using the front cover portion.

According to the vehicle front structure, engine sound to be emitted forward of the engine is soundproofed by the front cover portion of the engine soundproof cover. The air flow flowing from the vehicle front to the radiator is forcibly generated by the radiator fan. The air passing through the radiator and the radiator fan comes into contact with the front cover portion of the engine soundproof cover, and is guided upward of the engine. Therefore, this vehicle front structure can sufficiently supply the air from above the engine to the vehicle rear, even while a vehicle travels at low speed even during the low-speed traveling. Accordingly, the vehicle front structure can fulfill a soundproof function and can fulfill a cooling function even while the vehicle travels at low speed.

According to an embodiment, the engine soundproof cover may have an upper cover portion for covering an upper surface of the engine. The front cover portion may be configured to guide the air supplied from the radiator fan to an upper surface of the upper cover portion. The upper cover portion may include a pair of ribs disposed on the upper surface and extending to the vehicle rear. The rib may be an elastic member.

In this case, the engine sound emitted upward of the engine is soundproofed by the upper cover portion. The air passing through the radiator and the radiator fan comes into contact with the front cover portion of the engine soundproof cover, and is guided to the upper surface of the upper cover portion of the engine soundproof cover. The air supplied to the upper surface of the upper cover portion is guided to the vehicle rear by the pair of ribs. Accordingly, the engine sound can be further soundproofed, and the cooling function can be further fulfilled even while the vehicle travels at low speed. In the vehicle front structure, the rib is the elastic member. Accordingly, when the vehicle and an object come into contact with each other, it is possible to relieve an impact force applied to the object coming into contact with the vehicle.

According to an embodiment, the vehicle front structure may include an external air inlet disposed beside the radiator fan in the vehicle front and configured to introduce the air into an engine compartment. The engine soundproof cover may have a distribution cover portion located downstream of the external air inlet and in front of the engine. The distribution cover portion may be configured to distribute the air introduced from the external air inlet upward and downward inside the vehicle so as to guide the air to the engine and the vehicle rear. In this case, without using the radiator and the radiator fan, the external air is further fetched from the external air inlet into the engine compartment. The fetched external air is guided to the engine and the vehicle rear by the distribution cover portion. Therefore, in the vehicle front structure, the cooling function can be improved.

According to an embodiment, the vehicle front structure may include a transmission located beside the engine, and a transmission soundproof cover extending sideways and downward from the transmission with a gap left from the transmission. In this case, according to the vehicle front structure, a configuration can be adopted in which the sound emitted from the transmission is soundproofed and the transmission is less likely to be filled with heat.

According to the present disclosure, it is possible to provide the vehicle front structure in which the soundproof function can be fulfilled and the cooling function can be fulfilled even while the vehicle travels at low speed.

### BRIEF DESCRIPTION OF THE DRAWINGS

FIG. 1 is a schematic view showing an example of a vehicle front structure according to an embodiment.

FIG. 2 is a perspective view showing an example of the vehicle front structure according to the embodiment.

FIG. 3 is a top view showing an example of the vehicle front structure according to the embodiment.

FIG. 4 is a perspective view showing an example of an engine soundproof cover.

FIG. 5 is a perspective view showing an example of a transmission soundproof cover.

FIG. 6 is a schematic view for describing air guidance using a front cover portion and an upper cover portion.

FIG. 7 is a schematic view for describing air guidance using a distribution cover portion.

FIG. 8 is a schematic view for describing air guidance in the transmission soundproof cover.

### DETAILED DESCRIPTION

Hereinafter, an exemplary embodiment will be described with reference to the drawings. In the drawings, the same reference numerals will be given to the same or corresponding elements, and repeated description will not be omitted in the following description.

### Schematic Configuration of Vehicle Front Structure

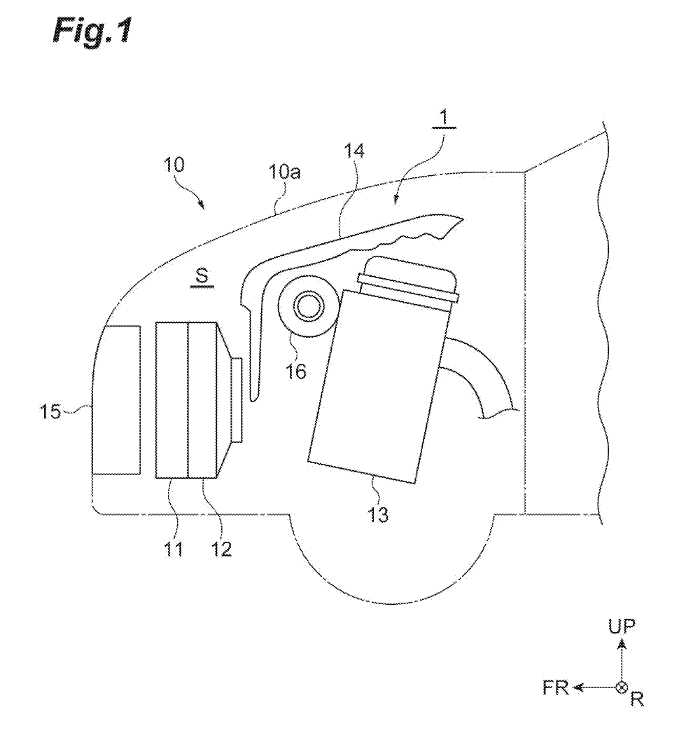

FIG. 1 is a schematic view showing an example of a vehicle front structure according to the embodiment. In the drawings, a front side in a vehicle longitudinal direction is indicated by “FR”, a rightward direction when viewed from a vehicle is indicated by “R”, and an upper side in a vehicle vertical direction is indicated by “UP”. As shown in FIG. 1, a vehicle front structure 1 is located on a front side of a vehicle 10. As an example, the vehicle 10 is a passenger vehicle, and is a front-wheel drive vehicle.

The vehicle front structure 1 has a radiator 11, a radiator fan 12, an engine 13, and an engine soundproof cover 14.

The radiator 11 is a heat exchanger. The radiator 11 is located in a vehicle front. As a specific example, the radiator 11 is located in an engine compartment S defined by an engine hood 10a. In the engine compartment S, the radiator 11 is located behind an engine grill 15 disposed in a front end of the vehicle 10. In the radiator 11, external air (air) fetched into the engine compartment S from the engine grill 15 is used for heat exchange. As a specific example, the radiator 11 uses the external air so as to cool circulating cooling water of the engine 13. The radiator 11 causes the air used for heat exchange to pass through the rear of the vehicle 10.

The radiator fan 12 is a blower. The radiator fan 12 is located in a vehicle rear of the radiator 11 in the car compartment S. The radiator fan 12 generates an air flow flowing from the vehicle front to the radiator 11. The air flow draws the air into the engine compartment S. That is, the radiator fan 12 is operated so that the air is forcibly supplied from the engine grill 15 to the radiator 11.

The engine 13 is an internal combustion engine. An example of the engine 13 includes an engine on which a crankshaft is mounted in a vehicle width direction. The engine 13 is located in the vehicle rear of the radiator fan 12 in the engine compartment S. In the engine compartment S, an exhaust system component (not shown) for exhausting exhaust gas to the vehicle rear is located behind the engine 13. The exhaust gas passes below the exhaust system component and a vehicle body floor, and is exhausted from the muffler disposed on the rear side of the vehicle 10.

The engine soundproof cover 14 is a member formed of a material for soundproofing engine sound. Soundproofing means preventing a sound leakage by absorbing or blocking sound. The engine soundproof cover 14 is located so as to cover at least a portion of the engine 13. The engine soundproof cover 14 may be located so as to cover a configuration component associated with the engine 13. An example of the configuration component includes an alternator, a belt, and an intake manifold. In the drawing, an alternator 16 is shown as the example of the configuration component, and other devices and components are omitted in the drawing.

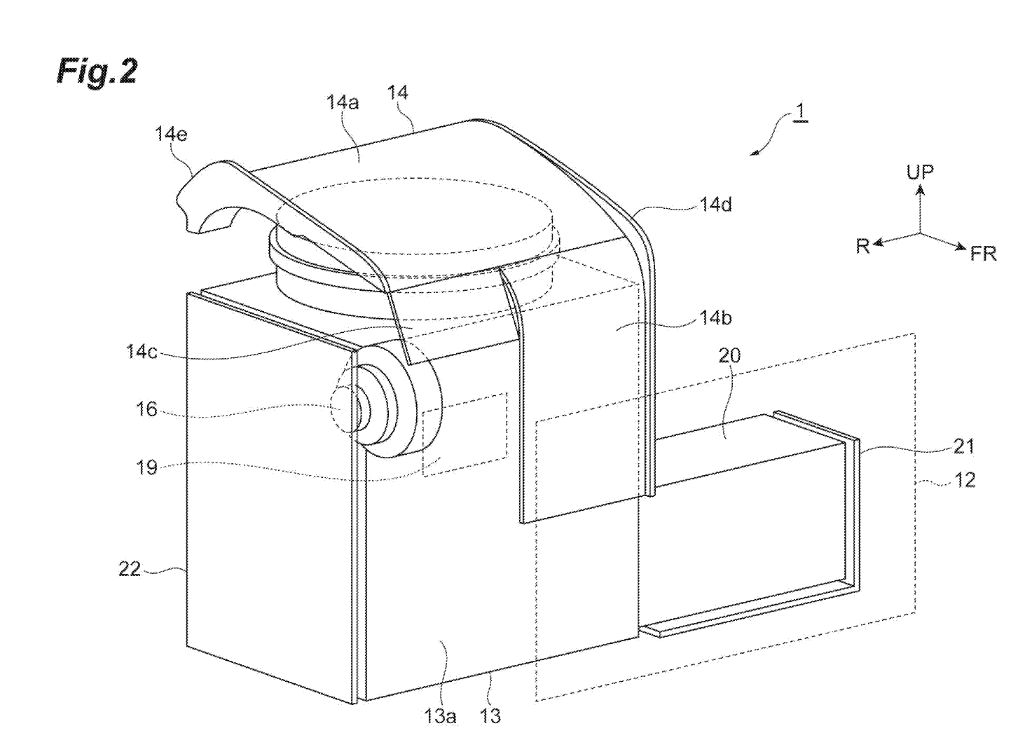

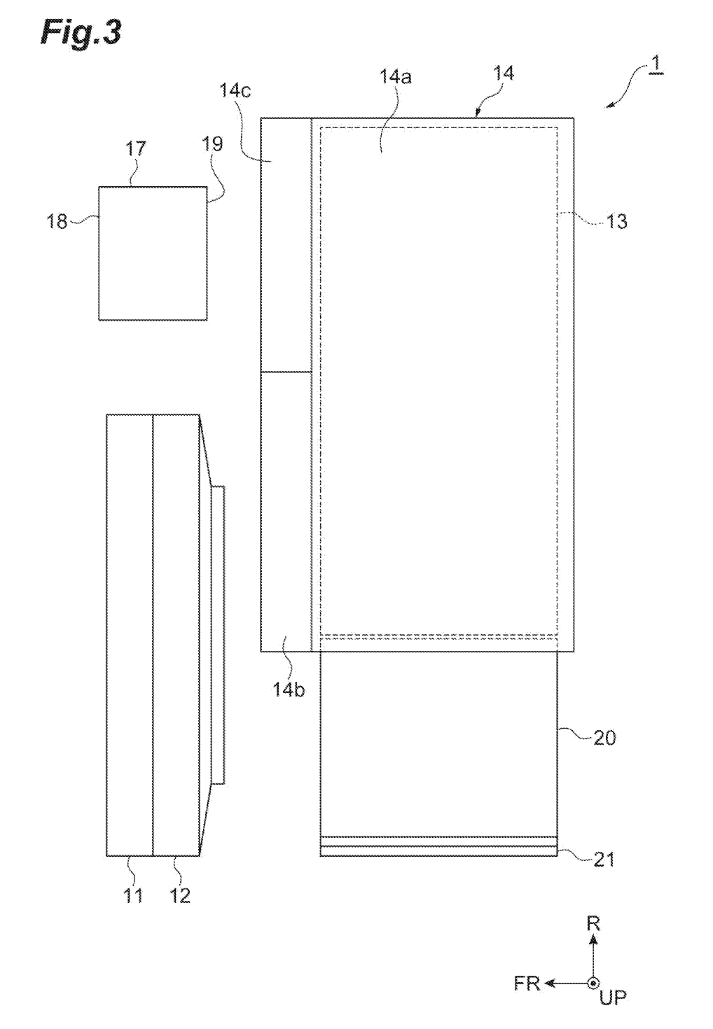

FIG. 2 is a perspective view showing an example of the vehicle front structure according to the embodiment. FIG. 3 is a top view showing an example of the vehicle front structure according to the embodiment. As shown in FIGS. 2 and 3, in the engine compartment S, a duct 17 is disposed in front of the engine 13 and beside the radiator fan 12. The duct 17 is a generally cylindrical member, and an end portion thereof has an inlet 18 and an outlet 19 (an example of an external air inlet). The inlet 18 of the duct 17 communicates with the outside of the vehicle 10. As an example, the inlet 18 of the duct 17 communicates with an opening formed in a front bumper (not shown). The outlet 19 of the duct 17 supplies the external air to the engine compartment S.

The vehicle front structure 1 includes a transmission 20 and a transmission soundproof cover 21. The transmission 20 is a gear box having a gear. The transmission 20 converts power of the engine 13 into torques and rotational speed which are suitable for traveling of the vehicle 10. The transmission 20 is located beside the engine 13. The transmission soundproof cover 21 is a member formed of a material for soundproofing the emitted from the transmission 20. The transmission soundproof cover 21 extends sideways and downward from the transmission 20 with a gap left from the transmission 20.

The vehicle front structure 1 includes a lateral soundproof cover 22 for covering a side surface of the engine 13. The lateral soundproof cover 22 is a substantially flat plate-shaped member formed of a material for soundproofing the engine sound. The lateral soundproof cover 22 is located so as to cover at least a portion of the side surface of the engine 13.

### Details of Engine Soundproof Cover

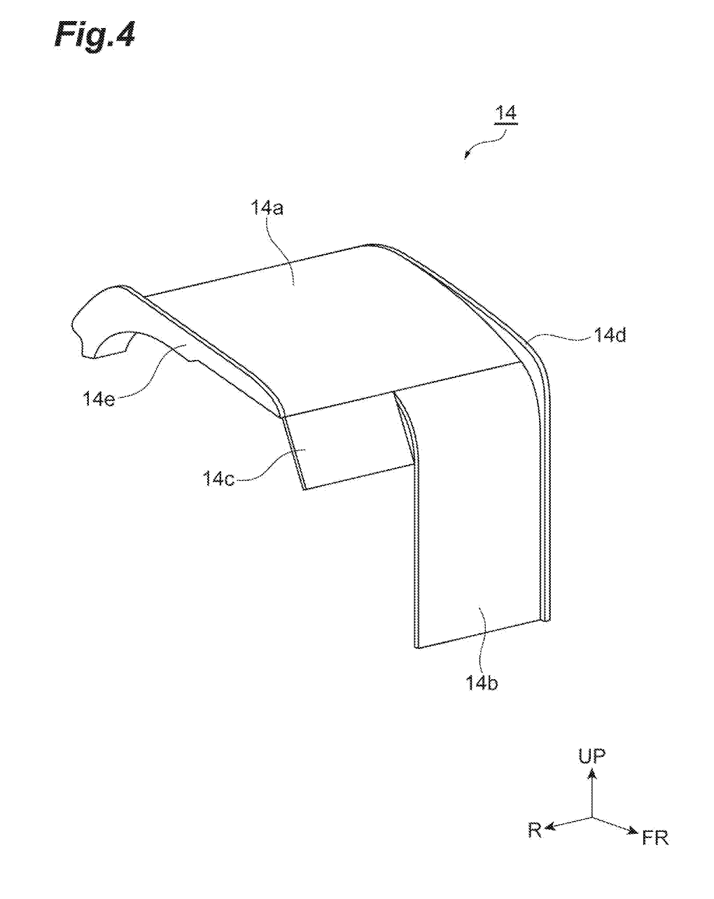

FIG. 4 is a perspective view showing an example of the engine soundproof cover. Details of the engine soundproof cover 14 will be described with reference to FIGS. 2 to 4. As shown in FIGS. 2 to 4, the engine soundproof cover 14 includes an upper cover portion 14a, a front cover portion 14b, and a distribution cover portion 14c.

The upper cover portion 14a covers an upper surface of the engine 13, in the engine soundproof cover 14. The upper cover portion 14a has a substantially flat plate shape. The upper cover portion 14a may be gently inclined toward the vehicle rear.

The front cover portion 14b covers a portion of a front surface 13a of the engine 13, in the engine soundproof cover 14. The front cover portion 14b has a substantially flat plate shape. The front cover portion 14b guides the air passing through the radiator fan 12 to flow upward of the engine 13. More specifically, the front cover portion 14b guides the air supplied from the radiator fan 12 to an upper surface of the upper cover portion 14a.

As a specific example, the front cover portion 14b is located so as to be interposed between the engine 13 and the radiator fan 12. That is, the radiator fan 12, the front cover portion 14b, and the engine 13 are arrayed in this order from the vehicle front. The radiator fan 12, the front cover portion 14b, and the engine 13 are positioned so as to overlap with each other when viewed in the vehicle longitudinal direction. A part of the front surface of the engine 13 is a predetermined area included in the front surface of the engine 13. A portion of the front surface of the engine 13 is a predetermined region included in the front surface of the engine 13. For example, the portion of the front surface of the engine 13 is a region facing the radiator fan 12. More specifically, the portion of the front surface of the engine 13 is a region where an air flow generated by the radiator fan 12 comes into contact with the engine 13. As a specific example, the front cover portion 14b is located so as to cover substantially the half of the front surface of the engine 13.

The front cover portion 14b extends downward from a front end of the upper cover portion 14a. As a specific example, a lower end of the front cover portion 14 b extends up to a position where the lower end reaches a height which is approximately half of that of the radiator fan 12. As an example, the front cover portion 14b is formed along the vehicle vertical direction. That is, an extending direction of the front cover portion 14b substantially coincides with the vehicle vertical direction.

In the engine soundproof cover 14, the distribution cover portion 14c is located downstream of the outlet 19 of the duct 17 and in front of the engine 13. The distribution cover portion 14c distributes the air introduced from the outlet 19 of the duct 17 so as to flow upward and downward of the vehicle, thereby guiding the air to the engine 13 and the vehicle rear.

As a specific example, the distribution cover portion 14c is located so as to be interposed between the engine 13 and the outlet 19 of the duct 17. That is, the outlet 19, the distribution cover portion 14c, and the engine 13 are arrayed in this order from the vehicle front. The outlet 19, the distribution cover portion 14c, and the engine 13 are positioned so as to overlap with each other in the vehicle longitudinal direction.

The distribution cover portion 14c is adjacent to the front cover portion 14b, and extends downward from a front end of the upper cover portion 14a, similar to the front cover portion 14b. A lower end of the distribution cover portion 14c extends to a position where the lower end reaches a height which is approximately half of or higher than that of the outlet 19. As an example, the distribution cover portion 14c is formed to form an angle with respect to the vehicle vertical direction. That is, an extending direction of the front cover portion 14b is oriented toward the vehicle front and downward, and is inclined with respect to the vehicle vertical direction.

The upper cover portion 14a includes a pair of ribs 14d and 14e disposed on an upper surface thereof and extending to the vehicle rear. For example, the ribs 14d and 14e are disposed in both ends in the vehicle width direction of the upper cover portion 14a. The rib 14d is formed to extend in the vehicle longitudinal direction along a left end portion of the upper cover portion 14a. The rib 14d may extend to the lower end of the front cover portion 14b. The rib 14e is formed to extend in the vehicle longitudinal direction along a right end portion of the upper cover portion 14a. The ribs 14d and 14e are elastic members. As a specific example, the ribs 14d and 14e are formed of a material such as rubber or sponge.

### Details of Transmission Soundproof Cover

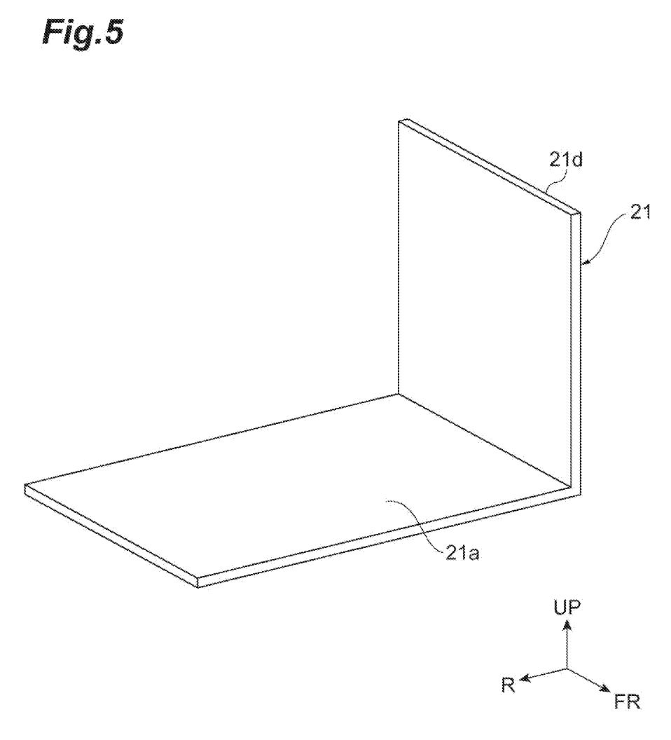

FIG. 5 is a perspective view showing an example of the transmission soundproof cover. As shown in FIG. 5, the transmission soundproof cover 21 has a bottom portion 21a and a side portion 21b. The bottom portion 21a and the side portion 21b are formed of a material for soundproofing the sound of the transmission, and have a substantially flat plate shape. The side portion 21b is erected on a left end portion of the bottom portion 21a.

### Advantageous Effect of Engine Soundproof Cover

The engine soundproof cover 14 is a member formed of a material for soundproofing the engine sound. Accordingly, the engine sound output outward of the engine compartment S can be reduced. The upper cover portion 14a of the engine soundproof cover 14 can soundproof the sound output upward from the engine 13. The front cover portion 14b and the distribution cover portion 14c of the engine soundproof cover 14 can soundproof the sound emitted from the engine 13 to the vehicle front.

If the vehicle front structure has a sound countermeasure structure (capsule structure), the engine 13 is covered with the soundproof cover. That is, the engine compartment S is partitioned. In this case, there is a possibility that the air inside the engine compartment S may be poorly ventilated. That is, due to the capsule structure, not only the engine compartment S is likely to be filled with the heat, but also the exhaust system component located behind the engine 13 is less likely to be cooled using the air. In contrast, as will be described below, the engine soundproof cover 14 can properly supply the air to the exhaust system component.

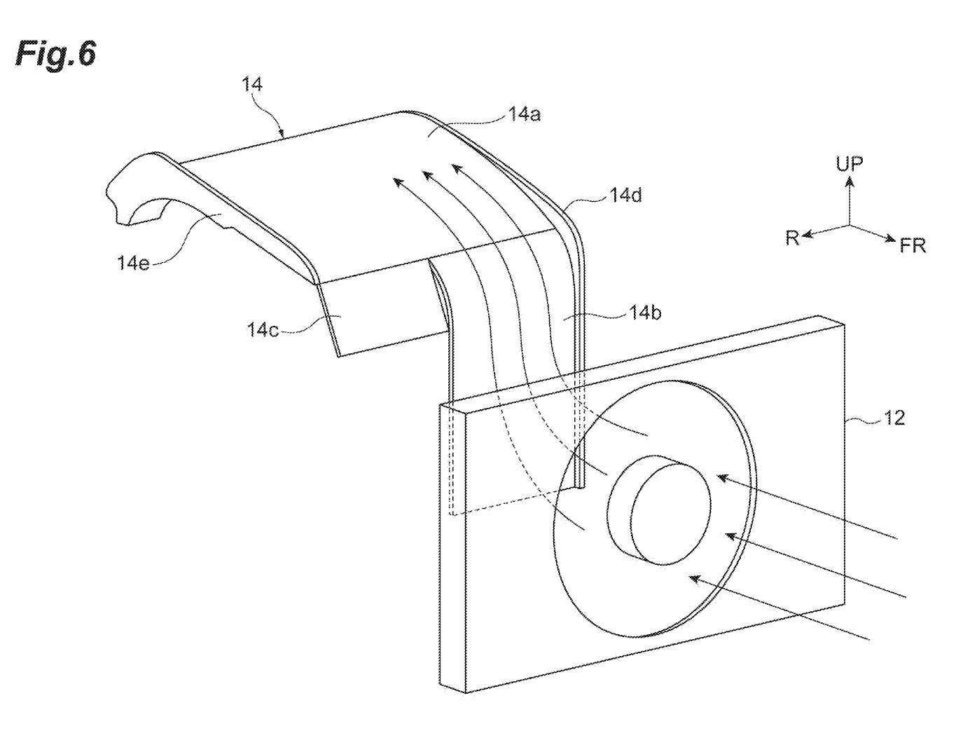

FIG. 6 is a schematic view for describing air guidance using the front cover portion and the upper cover portion. As shown in FIG. 6, the air flow generated by the radiator fan 12 comes into contact with the front cover portion 14b located in front of the engine 13, and rises along the surface of the front cover portion 14b. The rising air flow passes above the upper cover portion 14a, and reaches the exhaust system component in the vehicle rear. In this way, the front cover portion 14b can guide the air supplied from the radiator fan 12 to the upper surface of the upper cover portion 14a.

Furthermore, the air on the upper surface of the upper cover portion 14a is guided by the ribs 14d and 14e disposed in both ends of the upper cover portion 14a. Therefore, the air is not diffused on the upper surface of the upper cover portion 14a, and reaches the exhaust system component in the vehicle rear.

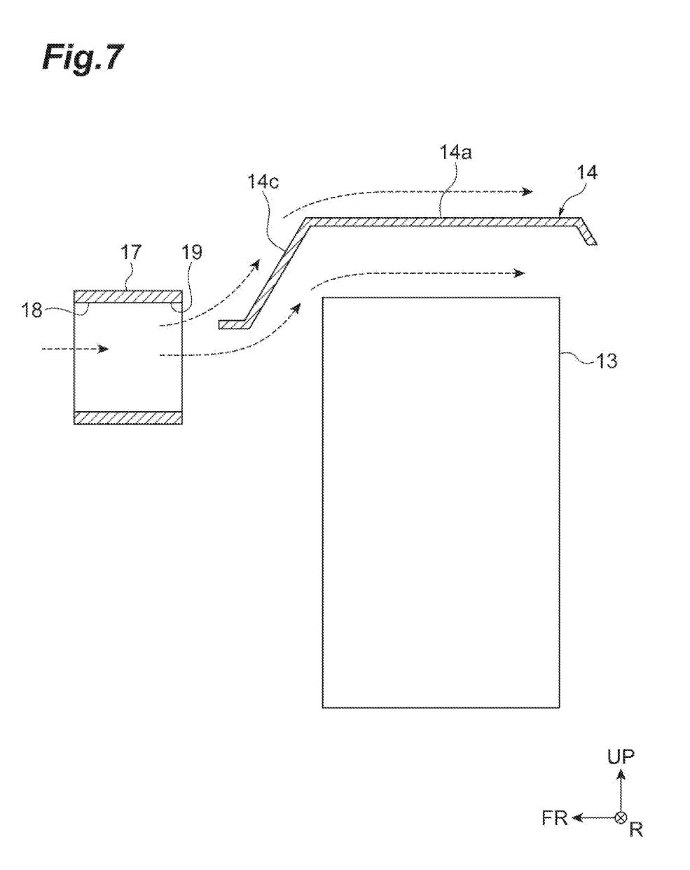

FIG. 7 is a schematic view for describing air guidance using the distribution cover portion. As shown in FIG. 7, the air supplied from the outlet 19 of the duct 17 is distributed upward and downward by the distribution cover portion 14c. The air distributed upward of the distribution cover portion 14c reaches the exhaust system component in the vehicle rear. The air distributed downward of the distribution cover portion 14c reaches the engine 13. In this way, the distribution cover portion 14c enables the air directly introduced from the external air to be supplied to the exhaust system component located behind the engine 13 and to the engine 13 (or the configuration component associated with the engine 13) at the same time.

In this way, the engine soundproof cover 14 can compatibly achieve soundproofing of the engine sound and cooling of the exhaust system component.

### Advantageous Effect of Transmission Soundproof Cover

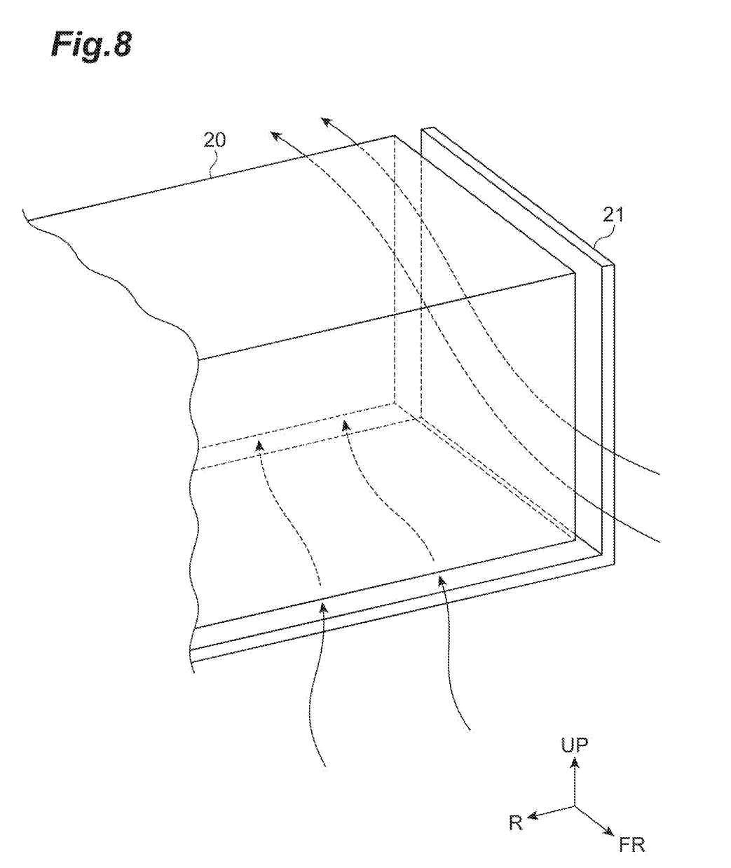

FIG. 8 is a schematic view for describing air guidance in the transmission soundproof cover. As shown in FIG. 8, the air flow generated by the radiator fan 12 passes through a gap between the transmission 20 and the transmission soundproof cover 21, and is supplied to the vehicle rear. In this way, the transmission soundproof cover 21 can compatibly achieve soundproofing of the sound emitted from the transmission 20 and cooling of the transmission 20.

### Summary of Embodiment

According to the vehicle front structure 1, the engine sound emitted forward of the engine 13 can be soundproofed by the front cover portion 14b of the engine soundproof cover 14. According to the vehicle front structure 1, the air passing through the radiator 11 and the radiator fan 12 can be guided upward of the engine 13 by the front cover portion 14b of the engine soundproof cover 14. Therefore, the vehicle front structure 1 can sufficiently supply the air from above the engine 13 to the vehicle rear even while the vehicle travels at low speed. Accordingly, the vehicle front structure 1 can fulfill the soundproof function, and can fulfill the cooling function even while the vehicle travels at low speed.

If the engine compartment S is filled with the heat on a mountain road in winter, the surface temperature of the engine hood 10a rises, thereby causing a possibility that a windshield may become foggy. According to the vehicle front structure 1, the cooling function inside the engine compartment S can be sufficiently fulfilled. Therefore, anti-fogging performance can be improved.

According to the vehicle front structure 1, the engine sound emitted upward of the engine 13 can be soundproofed by the upper cover portion 14a of the engine soundproof cover 14. In the vehicle front structure 1, the ribs 14d and 14e are the elastic members. Accordingly, when the vehicle 10 and an object come into contact with each other, an input from the engine hood 10a can be absorbed. Therefore, the vehicle front structure 1 can relieve an impact force applied to the object coming into contact with the vehicle.

According to the vehicle front structure 1, without using the radiator 11 and the radiator fan 12, the external air can be fetched from the duct 17 into the engine compartment S. Therefore, the vehicle front structure 1 can increase an air volume contributing to the cooling. Furthermore, according to the vehicle front structure 1, the fetched external air can be guided to the engine 13 and the vehicle rear by the distribution cover portion 14c. Therefore, the vehicle front structure 1 can increase the air volume contributing to the cooling, and can properly distribute the air to a cooling target location.

According to the vehicle front structure 1, the vehicle front structure 1 includes the transmission soundproof cover 21. In this manner, a configuration can be adopted in which the sound emitted from the transmission 20 is soundproofed and the transmission 20 is less likely to be filled with the heat.

According to the vehicle front structure 1, the vehicle front structure 1 includes the lateral soundproof cover 22. In this manner, the sound emitted sideways from the engine 13 can be soundproofed.

The above-described embodiment can be realized in various forms in which various modifications and improvements are made based on the knowledge of those skilled in the art.

As long as the vehicle front structure 1 includes the radiator 11, the radiator fan 12, the engine 13, and the engine soundproof cover 14, the vehicle front structure 1 may not necessarily include the transmission soundproof cover 21.

As long as the engine soundproof cover 14 includes the front cover portion 14b, the engine soundproof cover 14 may not necessarily include the upper cover portion 14a and the distribution cover portion 14c. The vehicle front structure 1 may not include the ribs 14d and 14e and the lateral soundproof cover 22.

An example has been described in which the upper cover portion 14a, the front cover portion 14b, and the distribution cover portion 14c are integrally configured to serve as the engine soundproof cover 14. However, the present disclosure is not limited thereto. For example, the upper cover portion 14a, the front cover portion 14b, and the distribution cover portion 14c may be formed to serve as independent members, and the engine soundproof cover 14 may be configured so that these members are assembled to each other.

What is claimed is:

1. A vehicle front structure comprising:
a radiator located in a vehicle front and configured to guide air to pass through a vehicle rear;
a radiator fan located in the vehicle rear of the radiator and configured to generate an air flow flowing from the vehicle front to the radiator;
an engine located in the vehicle rear of the radiator fan; and
an engine soundproof cover having a front cover portion for covering a portion of a front surface of the engine, and configured to guide the air passing through the radiator fan so as to flow upward of the engine by using the front cover portion.

2. The vehicle front structure according to claim 1, wherein
the engine soundproof cover has an upper cover portion for covering an upper surface of the engine,
the front cover portion guides the air supplied from the radiator fan to an upper surface of the upper cover portion,
the upper cover portion includes a pair of ribs disposed on the upper surface and extending to the vehicle rear, and
the rib is an elastic member.

3. The vehicle front structure according to claim 1, further comprising an external air inlet disposed beside the radiator fan in the vehicle front and configured to introduce the air into an engine compartment,
wherein the engine soundproof cover has a distribution cover portion located downstream of the external air inlet and in front of the engine, and
the distribution cover portion is configured to distribute the air introduced from the external air inlet upward and downward inside the vehicle so as to guide the air to the engine and the vehicle rear.

4. The vehicle front structure according to claim 2, further comprising an external air inlet disposed beside the radiator fan in the vehicle front and configured to introduce the air into an engine compartment,
wherein the engine soundproof cover has a distribution cover portion located downstream of the external air inlet and in front of the engine, and
the distribution cover portion is configured to distribute the air introduced from the external air inlet upward and downward inside the vehicle so as to guide the air to the engine and the vehicle rear.

5. The vehicle front structure according to claim 1, further comprising:
a transmission located beside the engine; and
a transmission soundproof cover extending sideways and downward from the transmission with a gap left from the transmission.

6. The vehicle front structure according to claim 2, further comprising:
a transmission located beside the engine; and
a transmission soundproof cover extending sideways and downward from the transmission with a gap left from the transmission.

7. The vehicle front structure according to claim 3, further comprising:
a transmission located beside the engine; and
a transmission soundproof cover extending sideways and downward from the transmission with a gap left from the transmission.

8. The vehicle front structure according to claim 4, further comprising:
a transmission located beside the engine; and
a transmission soundproof cover extending sideways and downward from the transmission with a gap left from the transmission.
